(19) United States
(12) Patent Application Publication
(10) Pub. No.: US 2004/0250142 A1
(43) Pub. Date: Dec. 9, 2004

(54) UV2D reader, age verification and license validation system

(76) Inventor: David M. Feyler, Westwood, MA (US)

Correspondence Address: David M. Feyler, 20 Baker Street, Westwood, MA, 02090, US

(21) Appl. No.: 10/809,325

(22) Filed: Mar. 26, 2004

Related U.S. Application Data
(60) Provisional application No. 60/458,101, filed on Mar. 28, 2003.

(51) Int. Cl. H04L 9/32

(52) U.S. Cl. 713/202

(57) ABSTRACT

The UV2D reader reads the information encoded on the back of a Driver' License, Liquor ID, Identification card, Military ID, Government ID, Corporate ID or any ID where information is being sent to a host devise. Upon receiving the license data, the host device can send a command to the UV2D imager to trigger the UV led board for any duration of time to enable the user to authenticate the License or Id being read. This command can also be used in conjunction with data gathered by a magnetic strip, smart cards, or keyed data.

### CROSS-REFERENCE TO RELATED APPLICATIONS

Applicant claim the priority benefits of U.S provisional Patent Application No. 60/458,101, filed Mar. 28, 2003

### BACKGROUND OF THE INVENTION

This invention relates to electronic devices capable of reading Ids in particular, to an apparatus for Verifying validity of Drivers license, Identification Card, Military Card, Government ID, Corporate ID or Any ID that has a hidden UV security feature that can be detected. System may determine age, town, Address, zip, license number, expiration date, height, weight, hair color, eye color or any pertinent Information embedded within the ID.

Certain products, such as alcoholic beverages, tobacco and lottery tickets, may not be sold to minors. Accordingly, vendors of such products are generally required to verify the age of buyers who appear to be Underage. For the most part, visually reading the customer's driver's license and calculating the buyer's Age, is the manual way of verifying a customer's age. There are several problems with visual age Verification with a driver's license. First of all, the person reading the ID may miscalculate the customer's Age. Secondly, the driver's license may have either been altered or may be an outright counterfeit.

Most licenses issued today have driver information encoded on a magnetic strip or bar code imprinted or attached to a driver's license. Many devices in the prior art have been developed which can interpret either a magnetic strip or bar code and provide some form of display. However, it has become common, especially for underage buyers to counterfeit a driver's license, which mimics the real thing. Example in MA the majority of all MA counterfeit drivers licenses look authentic to the naked eye. The back of the license has pdf417 code also, which can be read through most devices. The problem here is the counterfeiters have written their own pfd417 code, which enables them to imprint information that, will correspond to the front of the counterfeit driver's license. In doing so the counterfeit driver's license is able to get through any devise reading pdf417 code for age verification. This exact problem is also prevalent in States like Texas and California were counterfeiters have embedded mag strips with whatever information they want the end user of the counterfeit ID to reveal. Most of the States today have some sort of hidden security feature embedded in the driver's license. These hidden marks are generally not visible to the naked eye but is visible when exposed to an ultra violet light source. Some of the licenses today have micro printing, which can be easily read with 8× magnification. The ability for counterfeiters to write there own pdf417 code or mag stripe code is becoming a problem for retailers, restaurants, gaming institutions, Government agencies, banks, or anywhere a license needs to be better validated. The objective in the liquor and tobacco industry is not to sell age sensitive products to minors. A minor may be able to produce a counterfeit license, which looks authentic to the naked eye, and may have a counterfeit code embedded within it, that mimics that of an authentic ID. A devise that is just capable of reading the magnetic strip or bar code can give information that claims a minor is old enough to purchase liquor or tobacco when they are not. That devise then has not helped prevent the sale of the age-restricted product to minors. Another example would be a bank. If a bank has a devise that is capable of reading a driver's license but not capable of reading the hidden security feature embedded in the driver's license, then Identity theft is much easier done for the same reason mentioned above. Many government agencies and airports are now using devices that is capable of reading a driver's license. The impact of a counterfeit that reads threw a devise and produces false information can also have great ramifications to our national security.

### SUMMARY OF THE INVENTION

The present invention addresses the above problems by providing a system which can read and interpret a drivers license magnetic strip, linear bar code, pdf417 code or smart card and also illuminate any states Ultra Violet hidden security feature embedded within the driver's license. The present invention, therefore, not only verifies the age on the buyer's drivers license and all other pertinent information but also illuminates any states hidden Ultra violet security feature. The present invention can determine after reading the mag stripe, pdf417 code or smart card whether to turn on the UV leds to interpret those states hidden security feature. This enables the end user to not only to read the pdf417 code, linear bar code, magnetic stripe or smart cards but also if that license has a hidden UV feature that they are able to view that hidden security feature. The present invention turns on the UV LED's after reading the states code and determining whether or not that particular state has an UV security feature. In MA for example it has become widely evident that it is not effective to only read the pdf417 code, because the counterfeiters are writing their own pdf code. The present invention will read the linear, pdf417 code, mag stripe or smart card and a command will be sent to turn on the UV leds if that state has an UV security feature embedded in it.

The present invention accomplishes this by having one or all of the following, a magnetic strip reader, smart card reader, a bar code reader capable of reading linear barcode, i.e., one dimensional (1d), and stacked linear braced, i.e., two dimensional (2d), such as a high- density stacked linear symbology know as PDF417 (Portable Data File), Host Device such as a credit card terminal or CPU. In connection with the above reader, the invention contains an Ultra Violet

LED light board, adapted to shine onto the driver's license thereby exposing Ultra Violet security features embedded into a driver's license, liquor Identification card, Identification card, Government ID, and Corporate ID or any ID. The above readers read the encoded information and transmit the encoded information to a microprocessor of a Credit card machine, computer or any hardware that can process the information.

Depending on the license the display screen can display the individuals age, sex, height, weight, license number, name, address, town, zip, expiration, date issued or any pertinent information embedded within the ID.

The 2D bar code reader has an UV LED board that is connected to the 2d reader. The UV board can be mounted inside or outside the reader's mold. There is a firmware command that can be sent to the imager to trigger the Uvleds for any duration of time set forth by the software of the host devise. The 2-D reader reads the linear or pdf417 embedded code and then the microprocessor sends the information to the display screen. The Host devise Software has the command to send the signal back to the UV2D reader to turn on the UV LEDS. The command is sent to the UV2d Reader whether the data is being read by the imager itself or by the magnetic card reader or smart card reader. Example a Texas driver's license has UV security features and is a magnetic strip license. The data after being read by the host would send the signal to turn on the UV LEDS of the UV2D Imager. One state may have more than one license in circulation at any time. The two licenses may look identical but one may have an UV security feature and one may not for that year issued. The firmware command for the UV2D imager gives a software engineer the tools they need to send the command only for the licenses that have the UV security feature and from what year that security feature starts and ends. There are many publications that give the UV security feature for each state and what dates that security feature is good from and until. One of these is the I.D checking guide, published by the Drivers License Guide Company Redwood City, Calif.

These together with other objects of the invention, along with various features of novelty which characterize the invention, are pointed out with particularity in the claims annexed hereto and forming a part of this disclosure. For a better understanding of the invention, it's operating advantages and the specific objects attained by its uses, reference should be had to the accompanying drawings and descriptive matter in which there is illustrated a preferred embodiment of the invention.

### BRIEF DESCRIPTION OF DRAWINGS

FIG. 1A is front view of a typical driver's license.

FIG. 1B is a rear view of a typical driver's license.

FIG. 2. Is a front perspective view of a license reader

FIG. 3 is a schematic view of the UV2D reader scanning a licens.

FIG. 4 Flow chart of how system works

FIG. 4A is a block diagram of the invention system

4B is a block diagram of the invention system

4C is a block diagram of the invention system

4D is a block diagram of the invention system

4E Shows different host terminals that the UV2D imager can be connected to

FIG. 5 is a drawing of actual imager with UV board. (UV2D reader)

FIG. 6 is a drawing of actual imager with mold opened up. (UV2D reader)

6A Top board is the LED power control and communication board

6B The bottom board are the camera control and decoding board. This is where the firmware resides.

FIG. 7. Is a drawing of actual imager with replaceable UV outside housing (UV2D reader)

FIG. 8. Is a System Schematic

FIG. 9. Is an example of software process if a driver's license is to be run threw the system but is not Limited to.

FIG. 10. Product example

FIG. 11. Product example

FIG. 12. System Overview, System Diagram

FIG. 13. Software Process

FIG. 14. Software Process

FIG. 15. System Overview and off shelf components

FIG. 16. System Overview

FIG. 17. Housing for uv2d reader

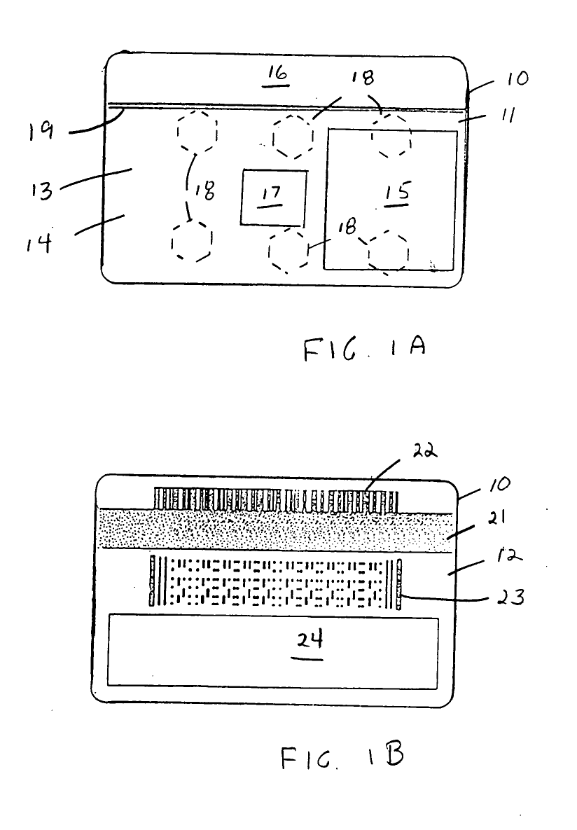

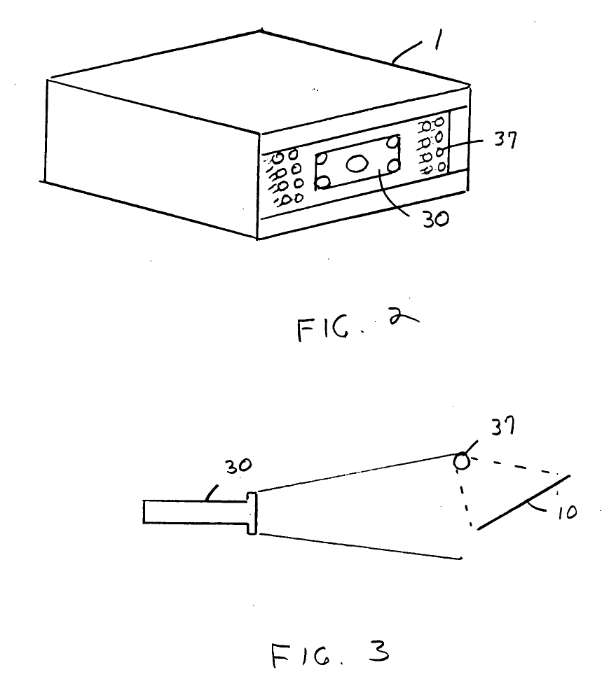

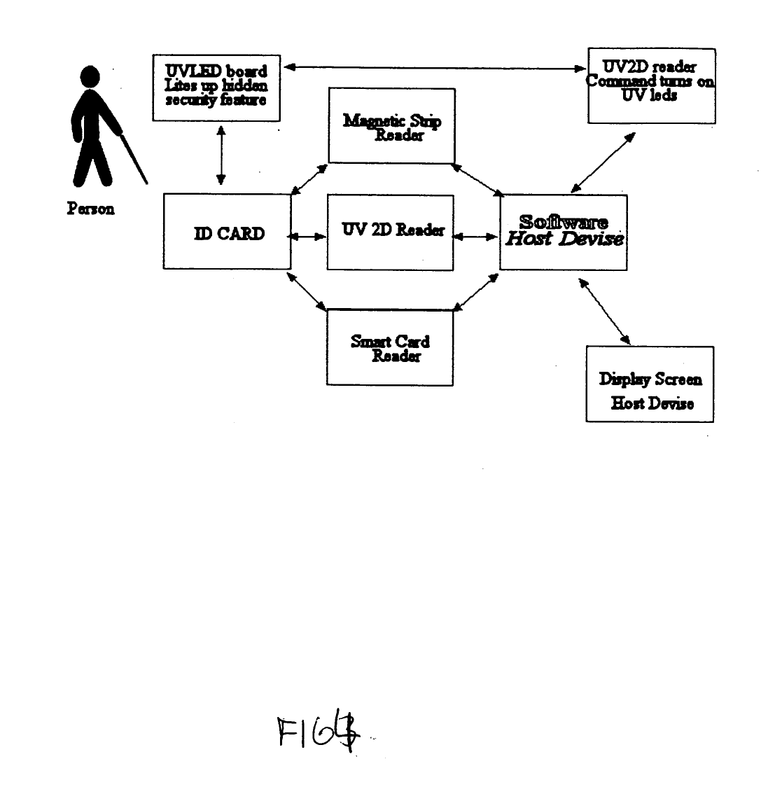

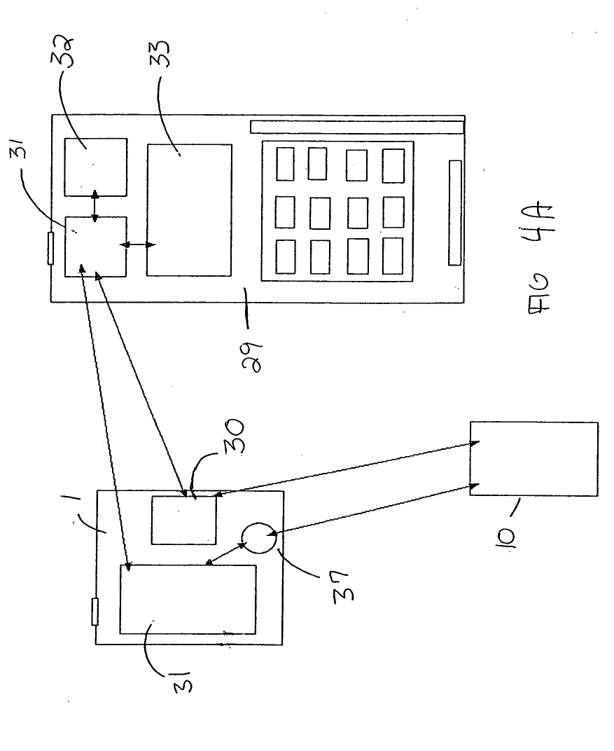

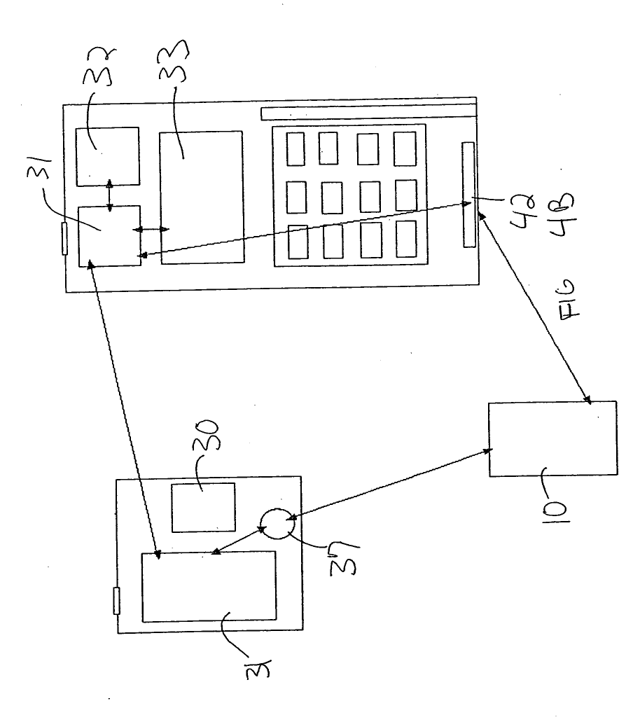

### DETAILED DESCRIPTION OF INVENTION

Referring to the drawings in detail wherein like elements are indicated by like numerals, there is shown a typical driver's license 10 with a front side 11 and a rear side 12. This could also be a typical identification card, immigration card, liquor ID card military identification card, company badge or bankcard. The license front side 11 usually contains: licensee biographic and identification data 13 such as name, address, date of birth, height, sex, etc.; pertinent license information 14 such as license number, driver class authorization, expiration date, etc.; licensee photograph 15; and jurisdiction 16. In most jurisdictions, the license front side 11 will also contain a ghost photo image 17 and one or more security features 18 that may be sensitive to Ultra Violet (UV) light. The license rear side 12 may be encoded with some or all of the information contained on the front side. The information may be encoded on a magnetic strip 21, a one-dimension bar code 22 and/ or a two- dimension bar code 23 know as pdf417 (defined by Symbol Technology Corporation of New York). The license rear 12 may also have an area 24 for applying a change of address label.

Various jurisdictions may have the above information and encoded means on one side or the other or both sides, including the security features. The layout of licenses and identification card for various jurisdictions is available from various industry publications, such s the I.D Checking Guide, published by the Drivers License Guide Company, Redwood City, Calif. For example, a 2003 Massachusetts's driver's license is imprinted with an Ultra Violet security feature across the front of the driver's license. Most all states have there own hidden security feature, many which light up under Ultra Violet light. These security features ranges from letters such as MA for Massachusetts to any Ultra Violet security marking that State Registry decides upon. Today a license may also have laser UV imbedded within the driver's license. This is a much more secure form of embedding a license with an Ultra Violet security feature because there are many tones and colors to these patterns. Degimarc Corporation which makes most of the drivers licenses in the United States has several colors, which it uses for states drivers licenses, liquor Ids, Identification cards, Corporate ID Government ID or any ID they manufacture. The most typical colors are lime green and blue but are not limited to. Degamarc also has an Ultra Violet security feature for IDs that can be seen with the naked eye but glows under Ultra Violet inspection. Most licenses today have either a magnetic strip, linear bar code or pdf417 code but are not limited to them. The military cards now have smart card chip within them. Most licenses today have a ghost photo image, Ultra Violet or holographic overlay, some licenses have micro printing also. There is other security features from raised lettering to pdf417 code that has a license holder's face embedded within the code. The newest of driver's license, which have laser Ultra Violet, imbedded within them is extremely hard to counterfeit.

The system 1 is comprised of a license reader 30 capable of reading a wide range of codes including 1d and 2d bar codes, matrix codes, optical codes, image capture. The reader unit 30 scans the code on the license 10 and passes the scanned code information to a central processor 31 for decoding. The system 1 after sending the information to be processed 31 and to be displayed on 33 of the host devise. The information being displayed on 33 of the host device may include Id holders age, address, town, zip code, license number expiration, hair color, weight, expiration, any pertinent information embedded within the code of the ID. Within 1 there is firmware that has a command that can be added to the host software 32 to send a signal back to 1 to trigger the Uvled board 37. Different license jurisdictions with dates of issue and expiration may be entered in to software application 32 to send the command to system 1 to trigger the Ultra Violet board 37 for those jurisdictions and date of issue. The software application 32 may be directed to look at the scanned code form a specific jurisdiction or specific date of issue to send command to the imager 1 to turn on Ultra Violet LEDS for any duration of time set forth by the software 32.

The system 1 is comprised of an UV light emitting diode (led) 37 adapted to shine onto the license 10 being scanned. Depending upon the jurisdiction of the license being scanned, the UV light 37 may be turned on and the host devise 29 will display on its display screen 33 “Check UV security”.

The system 1 with its firmware command enables the host devise 29 to have a command that can be entered into its software 32 to be able to send a signal back to the imager 1 to turn on the Uvleds for a specific ID. Jurisdiction is just one example of how the firmware command of 1 may be added to software of 32 to tell the U.V.LEDS to turn on. The software application 32 may use any pertinent information embedded within the ID to tell the Host devise 29 to send the signal back to the system 1 to turn on the UV LEDS 37. If a command is sent to the system 1 to turn on the UV LEDS and no security marking lights up then the ID is a counterfeit, even if its code displayed on the screen 33 of the host devise 29. For example if after system 1 reads the ID and send s the information threw 31,32 to display “John M Doe is 22” on display screen 33 doesn't mean that is the Id holders true age or name. All the Host devise is doing is displaying the information sent to it by system 1. If the above ID says after being scanned “Check UV security” John M Doe is 22 on the display screen of 33 and the signal is sent to turn on the UV LEDS 37 and No security feature lights up on 10 we know that license is a counterfeit even though Display screen 33 said that John M Doe is 22.

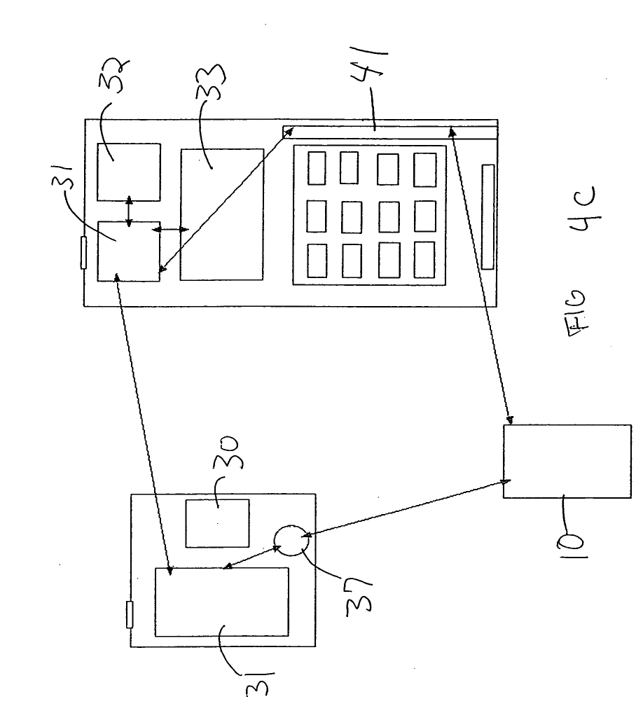

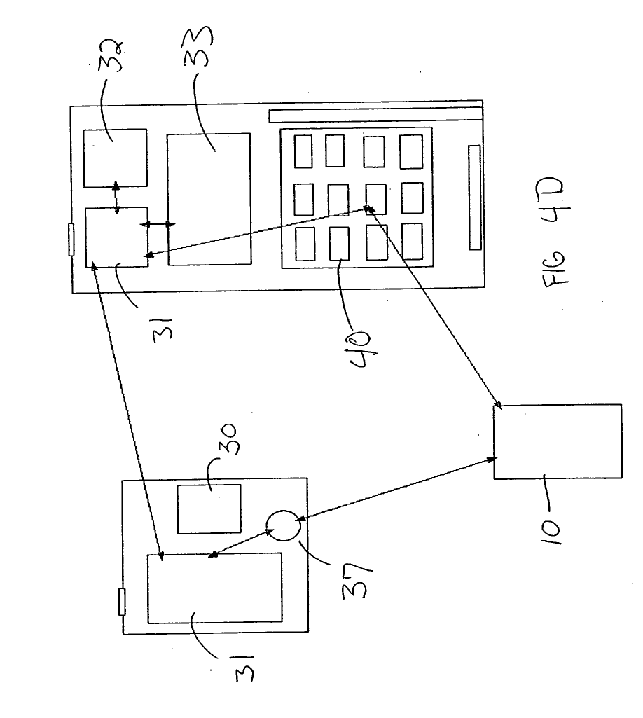

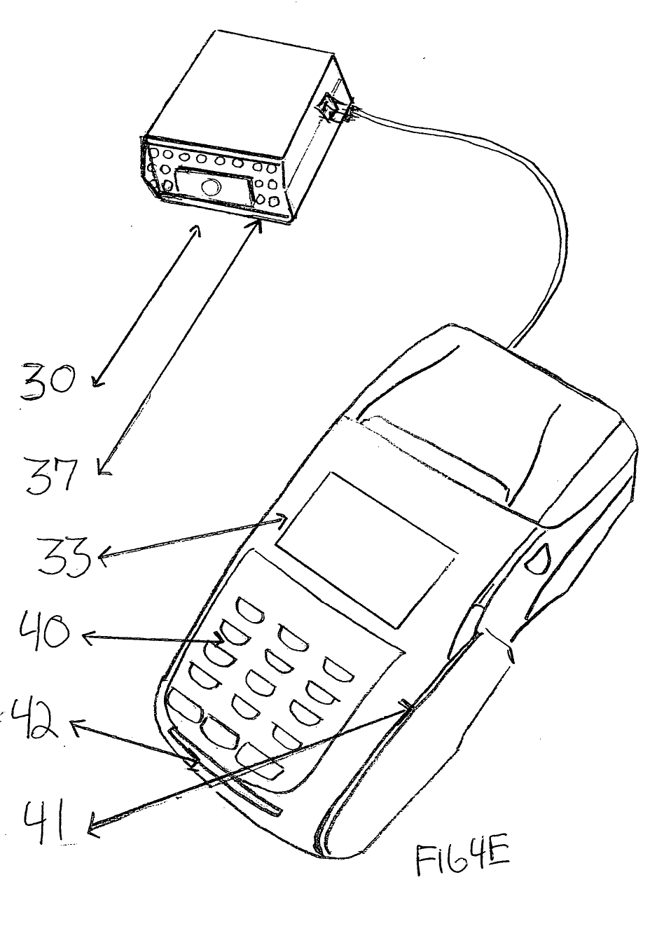

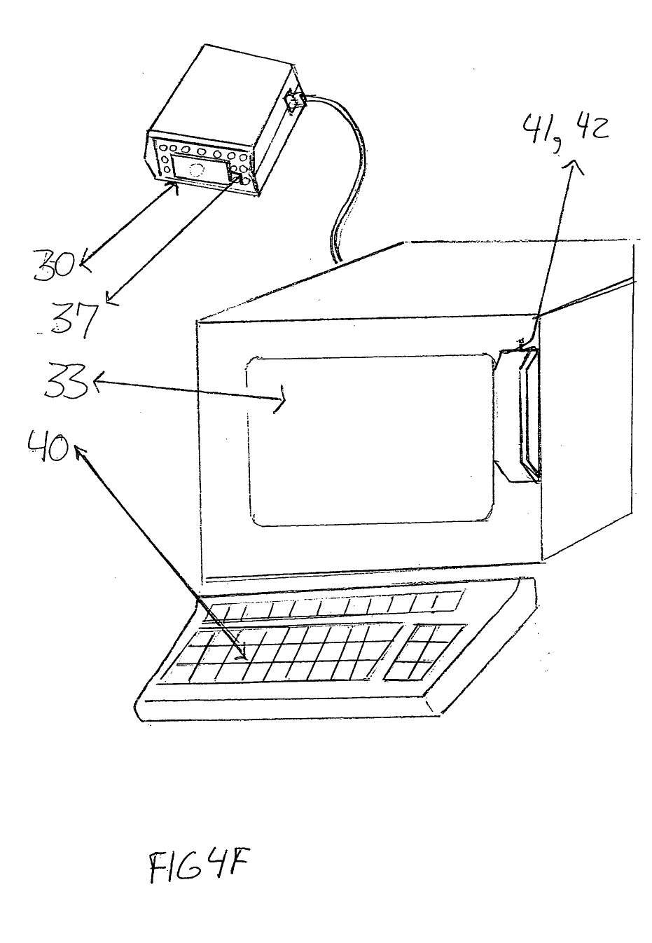

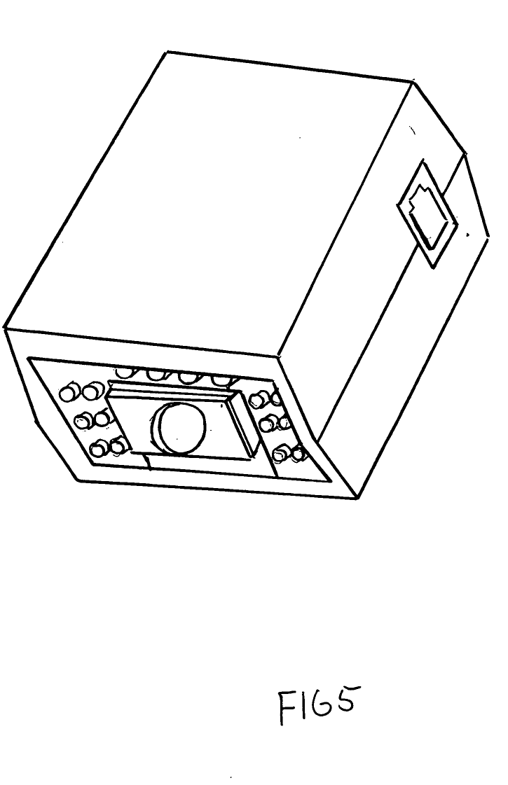

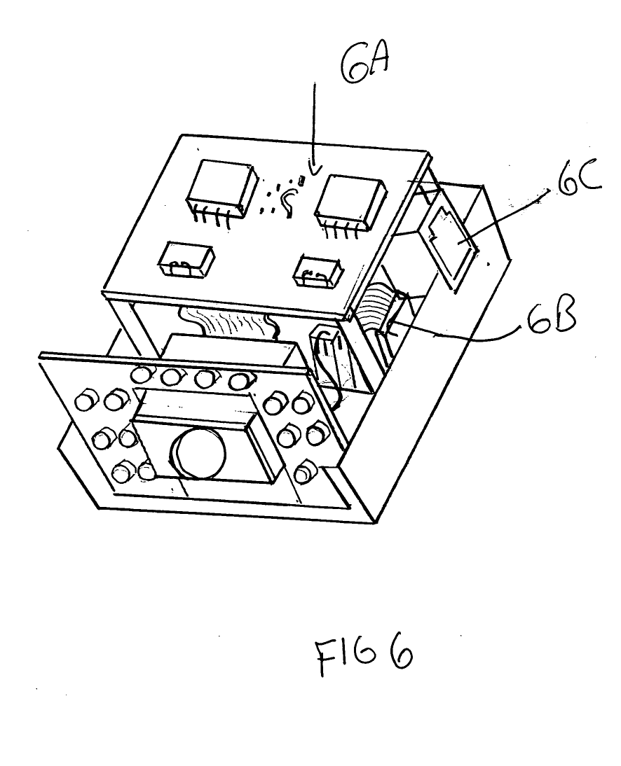

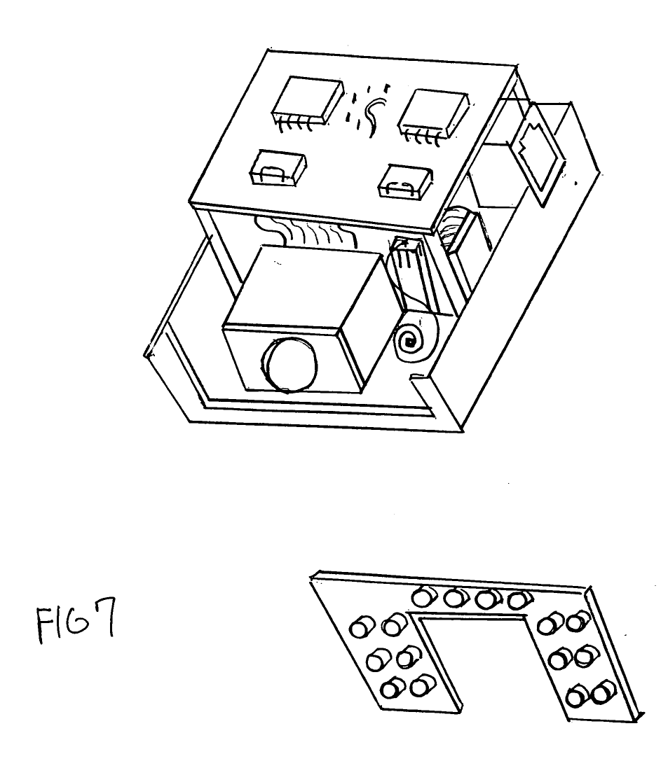

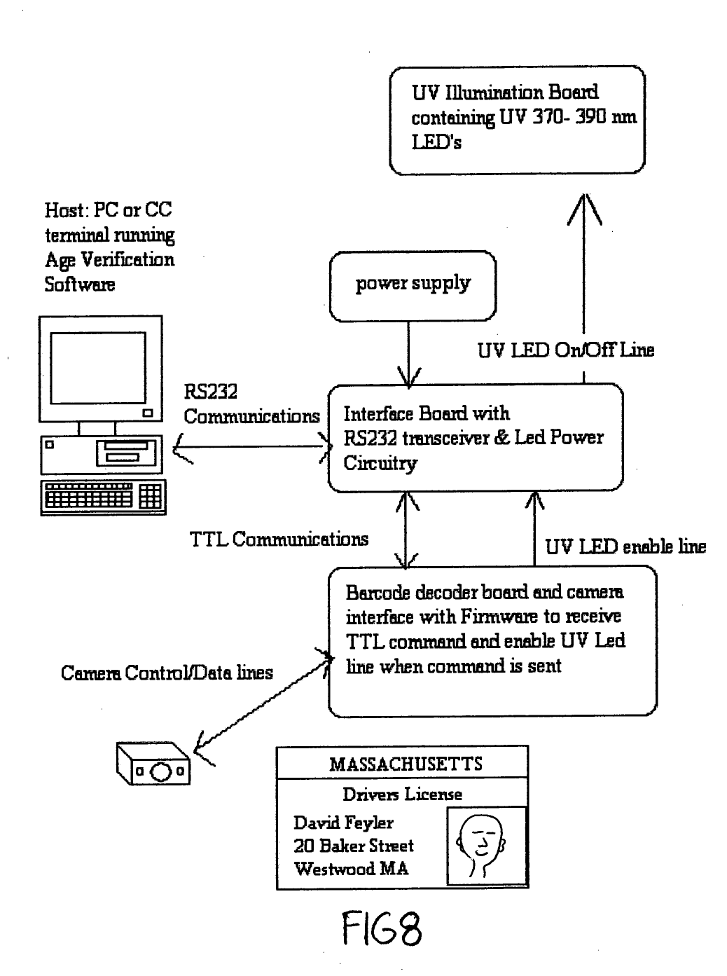

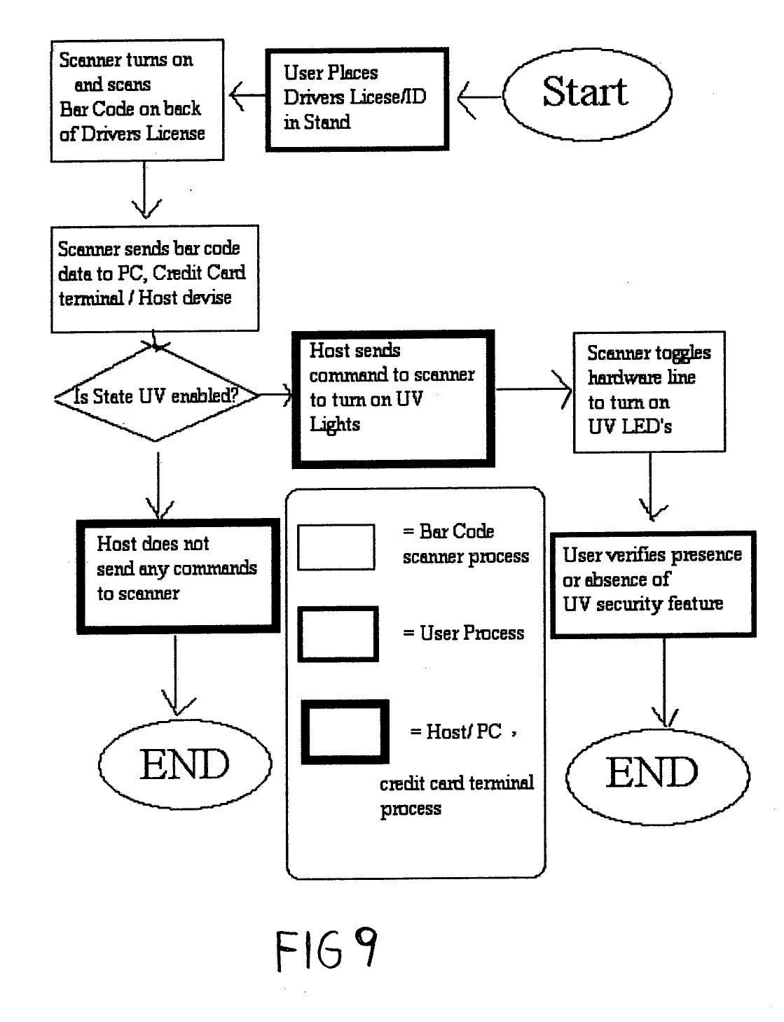

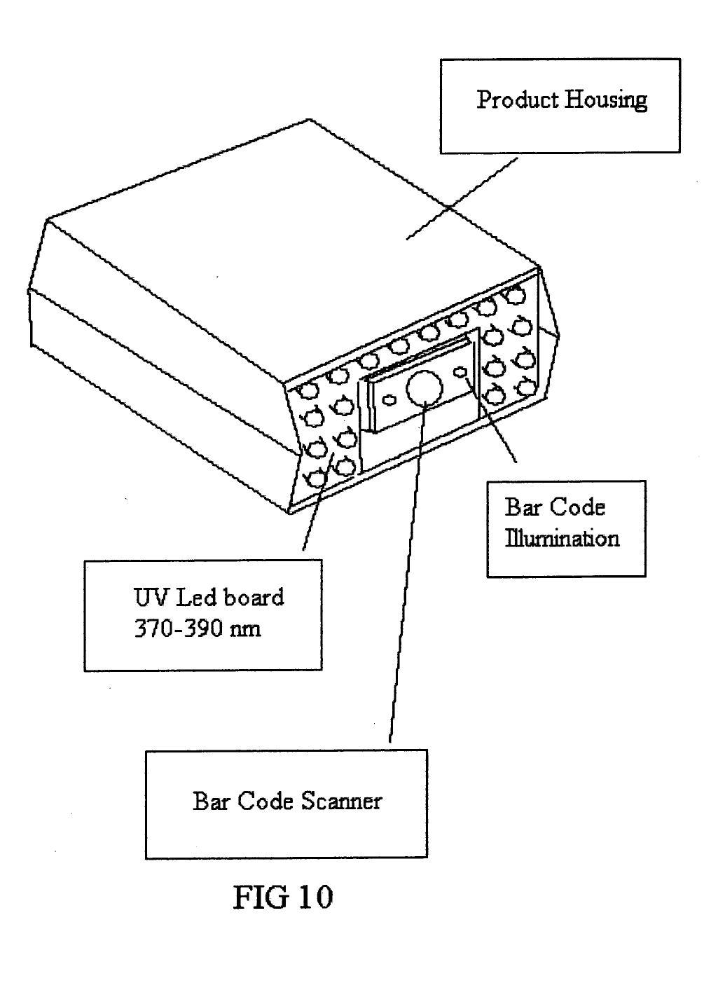

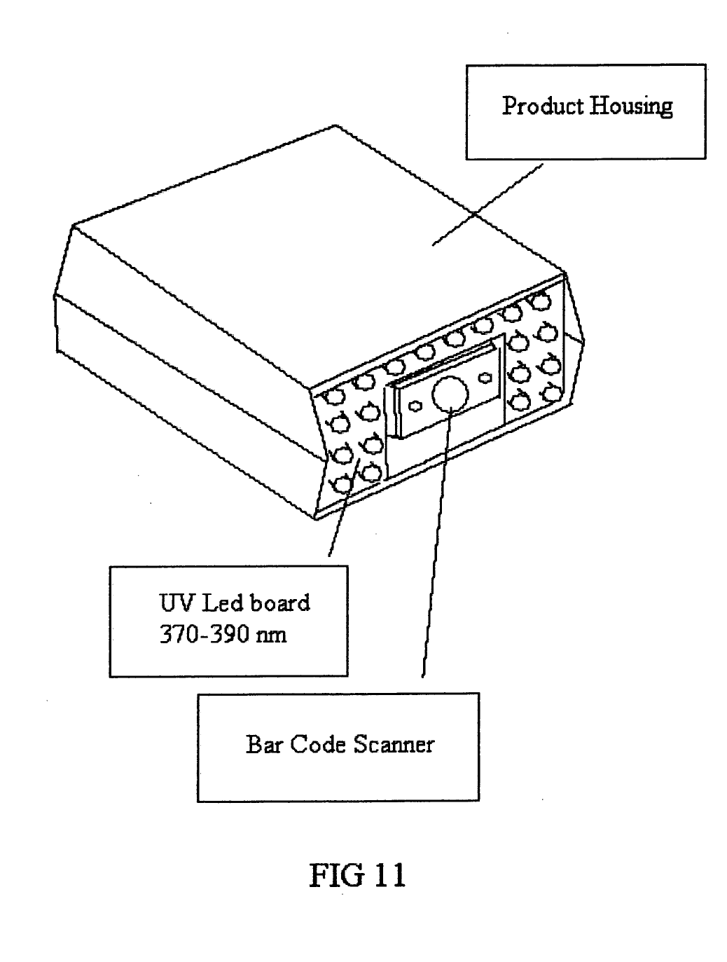

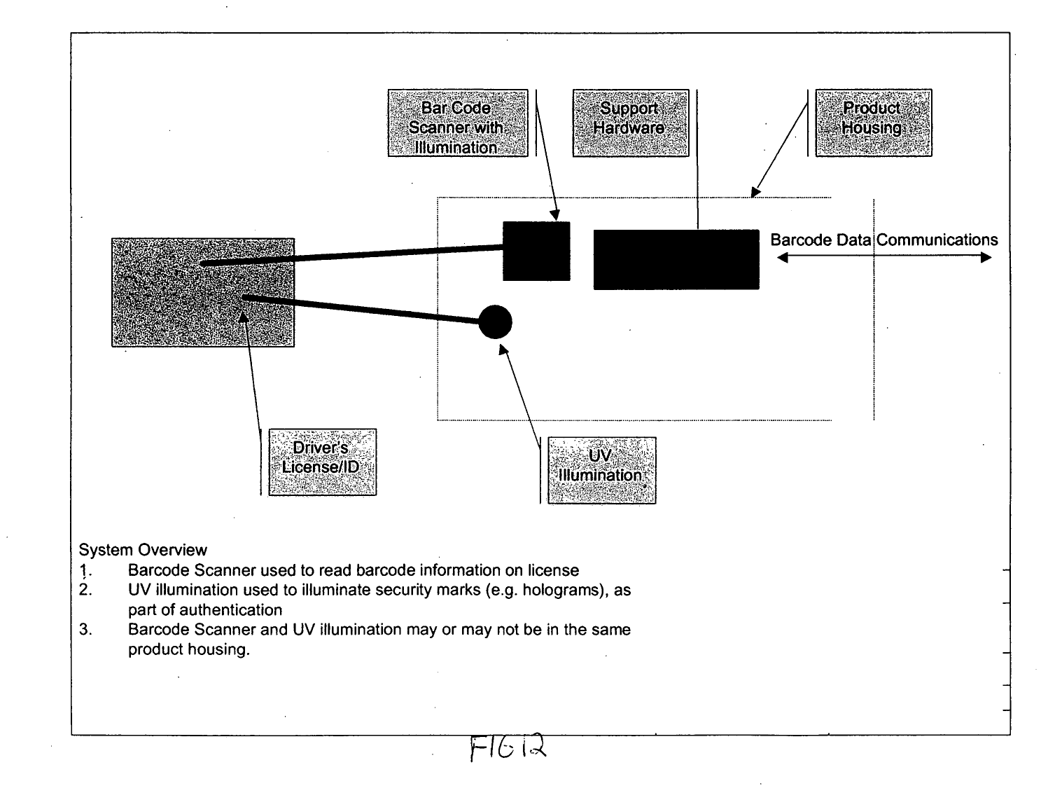

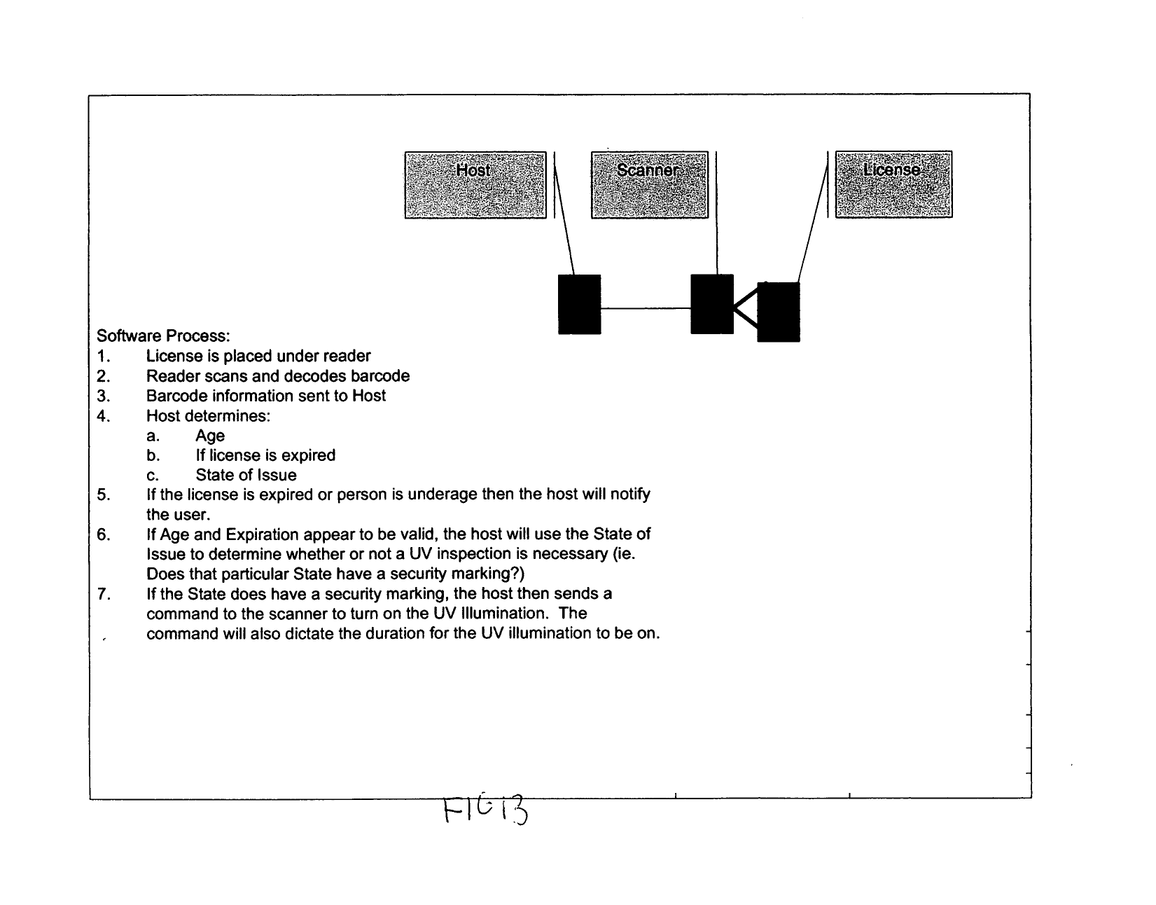

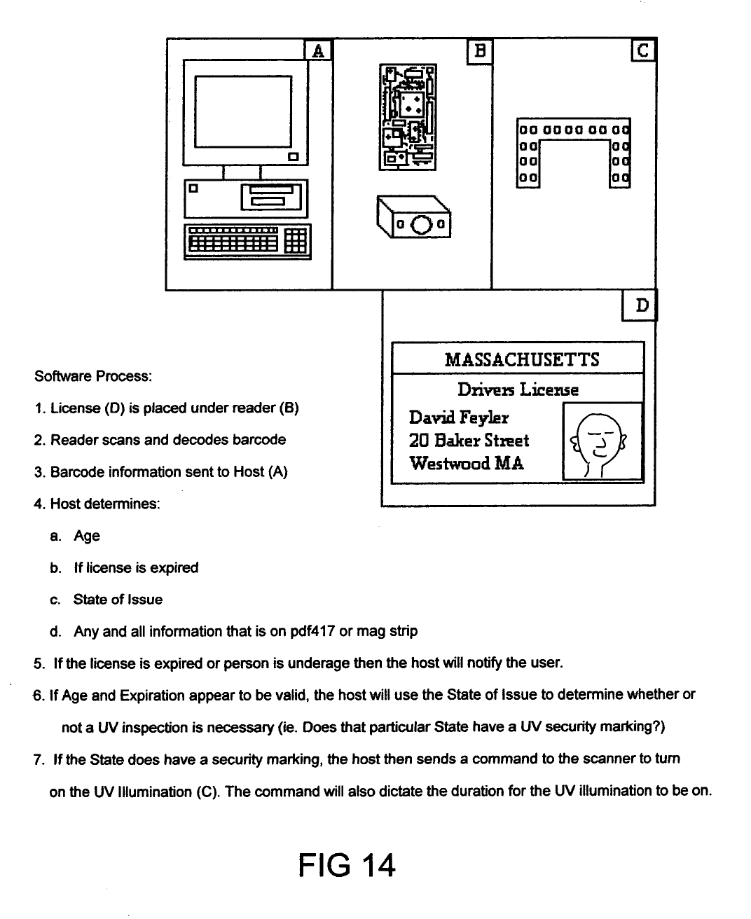

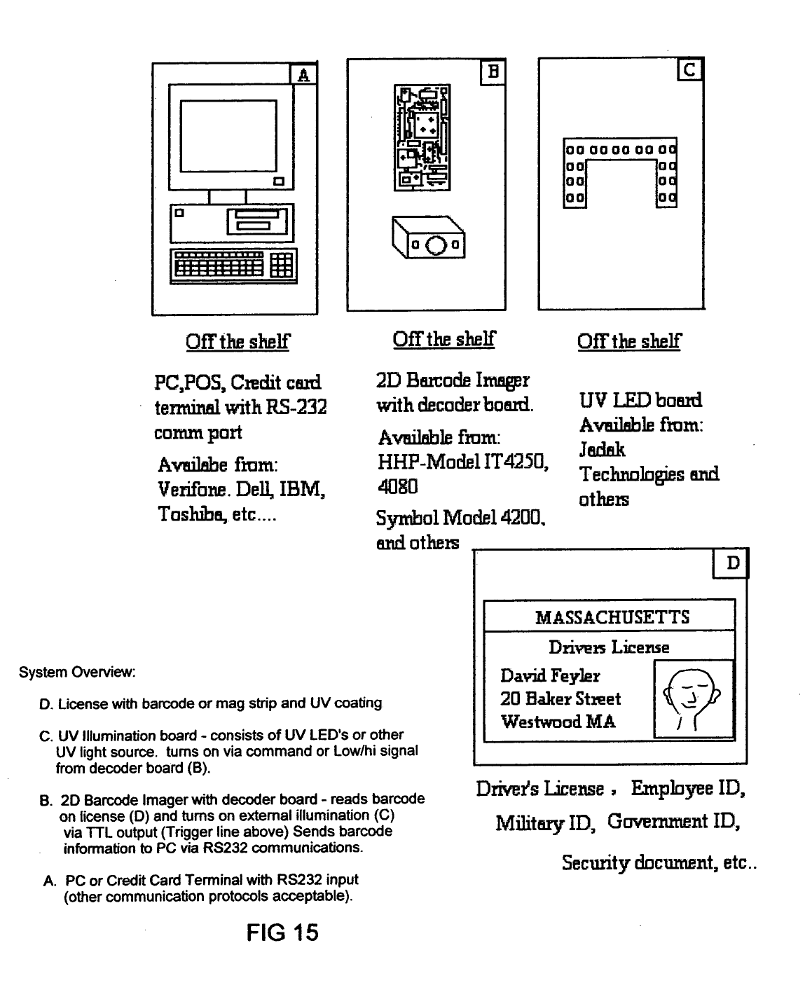

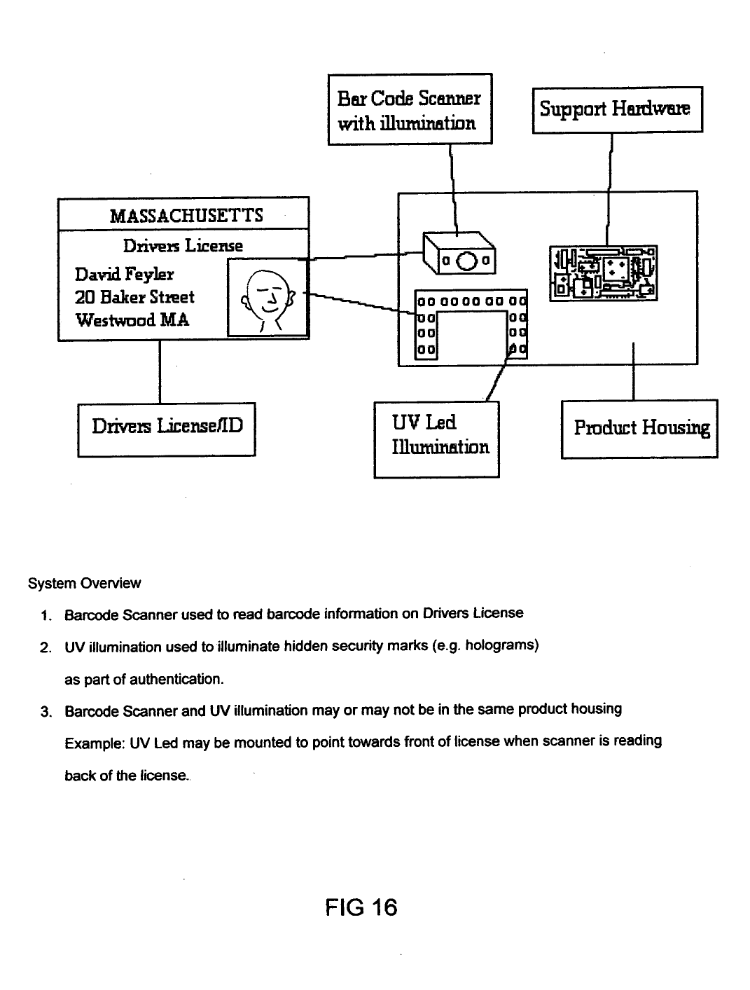

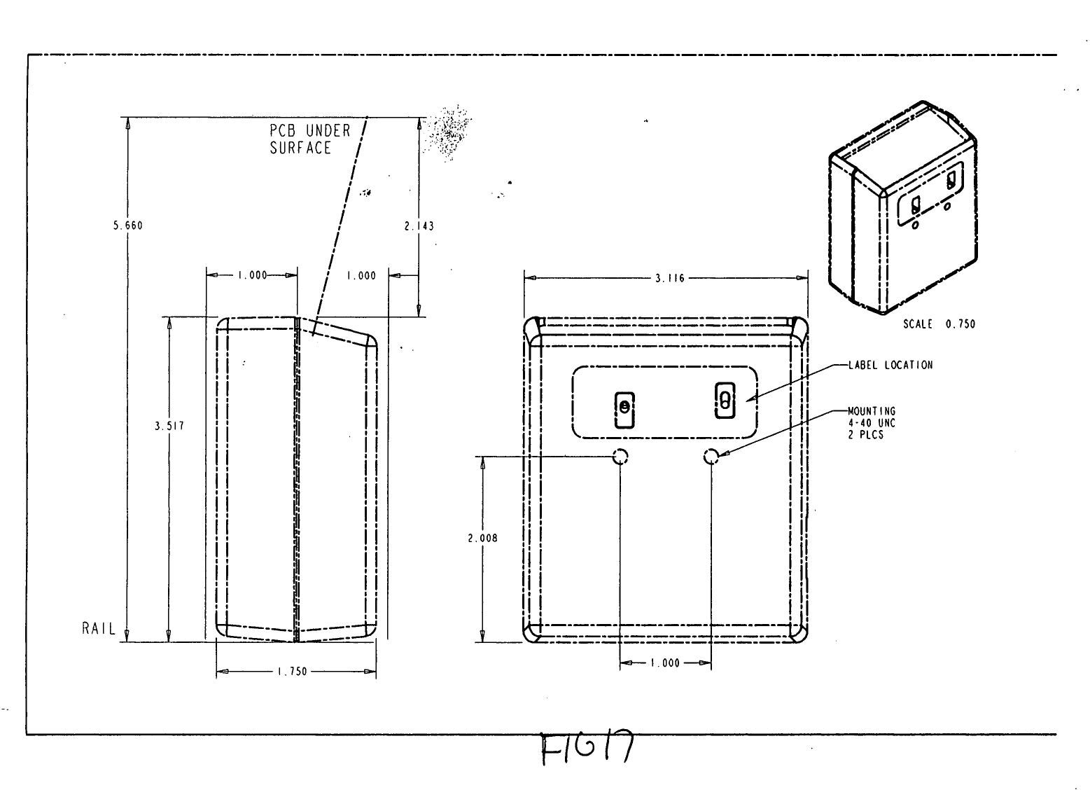

The command to turn on the UV LED board 37 can also be used in conjunction with data gathered by magnetic strip, smart cards, or keyed data. An example of this is shown in FIG. 4B, FIG. 4C, FIG. 4D. Counterfeiters are able to write their own code. For example if the display screen say s (JOHN DOE is 21 years of age) a counterfeiter may have written that information. If after reading the code and that license has a hidden UV security feature and no feature lights up then the license is a counterfeit even though the display screen said the gentleman was of age. In today's age it is not good enough to just read the code within the driver's license but it is much more secure to read the license code and security feature and be able to tell what licenses are suppose to have a hidden UV security feature within them.

In another embodiment of the invention, the system 1 has a ten-power loupe attached thereto. In some jurisdictions licenses 10 may have microprinting 19 on the license. In Massachusetts's example show, the word “Registry of Motor Vehicles” is microprinted just below the jurisdiction section 16. It is not discernible to the naked eye, but is visible under a ten-power loupe. This is another way for vendor to determine the validity of the license presented.

It is understood that the above- described embodiment is merely illustrative of the application. Other embodiments may be readily devised by those skilled in the art, which will embody the principles of the invention and fall within the spirit and scope thereof

What is claimed is

1. A method of validation of a Drivers License, Identification card, liquor ID, Government ID, Corporate ID, or any ID that has information embedded on it. Where a UV LED board will light up any hidden security feature embedded in any of the ID mentioned above. Where within the imager housing is firmware with a command that can be sent to it by the host devise to turn on the UV LEDS for any duration of time set forth by the host devise software application. The data being sent to the host devise to turn on the UV LEDS can be sent by the 2d Imager, magnetic card reader ,smart card reader or keyed entry.

2. A method of validation claim 1 wherein reading the embedded information on an ID with a 2D Imager, magnetic strip reader, smart card reader or keyed entry. The information to be displayed on the host terminal with any or all-pertinent information embedded within the ID. Example of pertinent information “Age, Town, State, expiration, date of issue, height, weight, hair color, sex, eye color, drivers classification, name, address.

3 A method of claim 1 Wherein not only reading the ID imbedded information but a method of illuminating the Hidden UV security if the ID has one.

4. A method of claim 1 wherein after the imager has read the data and the host devise is sending the signal back to the 2d imager to turn on the the UV LED board for what ever duration of time set forth in the software application.

5. In connection with claim 4 the host devise can also send a command to the UV2D Imager to turn on the UV LEDS if the data being read is by a magnetic strip reader, smart card reader, or keyed data The host devise can send the command back to the UV2D Imager to turn on the UV LEDS if the data being read has the trigger command to send the signal to turn on the UVLEDS.

6 A method of validating an ID described in claim 1, by adding a command that can be sent from the host devise to the UV2D imager to turn on its UV LED board. License Jurisdiction is an example of a trigger that will send the command to turn on the UV LEDS. Dates of issue in conjunction with Jurisdiction can also be used as the trigger to send the command to signal the UV2D imager to turn on the UVLEDS. Any pertinent information within the ID can be used as the trigger for the command to be

7. A method of claim 1, in validating an Id where in using an 8x loupe or greater to read the micro printing that is embedded in many IDs today.

8. A method of claim 1, with an 2D imager that has a UV board connected to it and has a firmware command that can be sent back to the 2D imager by a host devise to turn on that UV led board for what ever duration of time set forth in the software application. The UV board can also be set so it is always on.

9. In conjunction with claim 8 the UV LED board can be mounted within the same mold of the 2D-Imager mold or outside the 2D Imager mold.

10. A method of claim The UV LED board is replaceable.

11. A method of claim that Sending a signal back to the 2D imager from the host devise to beep if the ID has an UV security feature and can also activate various audible sounds.

12. Method of claim 1 wherein The display screen of the host devise will also tell the end user to “CHECK UV SECURITY”

13. A method of claim 1 Wherein the host devise is capable after information sent to it by the UV2D reader, mag strip reader or smart card reader to calculate a person's age and transmit any pertinent information on the ID to the display screen of the host terminal.

14. A method of validating a ID described in claim 1, a license for example is placed on the 2D Imagers lip and the reader is set in presentation mode which enables it to only turn on when it see a code or better yet a number of edges to tell the Imager to trip and read the code that has been presented to it. Then is sent to the host devise where it is interpeted and the data is displayed on the host display screen with whatever pertinent information the end user wants to display. If the data being read matches the data that has been set up in storage of the host devise to trigger the signal then the UV LED board will turn on.

15. A method of validating an ID described in claim 1 and in conjunction with claim 14 the UV2d Imager can also be turned on by scan stand mode, which is a linear bar code that is positioned on the lip of where the ID is presented. When that linear bar code is covered up it tells the 2D imager to read the code that has presented. The 2d reader can also be manually triggered or keyboard triggered to tell the reader to the information presented in front of it.
